(19) United States
(12) Patent Application Publication
(10) Pub. No.: US 2007/0182319 A1
(43) Pub. Date: Aug. 9, 2007

(54) Light emitting device with optical enhancement structure

(76) Inventors: An-Chi Wei, Keelung City (TW); Heng-Long Yang, Taipei City (TW); Han-Ping Shieh, Hsinchu City (TW)

Correspondence Address: LIU & LIU, 444 S. FLOWER STREET, SUITE 1750, LOS ANGELES, CA, 90071, US

(21) Appl. No.: 11/649,494

(22) Filed: Jan. 3, 2007

Related U.S. Application Data
(63) Continuation-in-part of application No. 10/939,017, filed on Sep. 9, 2004.
(63) Continuation-in-part of application No. 10/938,928, filed on Sep. 9, 2004, now abandoned.

(30) Foreign Application Priority Data
Sep. 9, 2003 (TW) 92124844
Sep. 12, 2003 (TW) 92125333

(51) Int. Cl. H01J 1/62; H01J 63/04

(52) U.S. Cl. 313/506; 313/501

(57) ABSTRACT

A light emitting device with optical enhancement structure. The light emitting device includes a light emitting element and an optical enhancement structure. Some of the light from the light emitting element is emitted in a diverging manner. The optical enhancement structure is optically coupled to the light emitting element, said optical enhancement structure having a light emerging surface that includes a central surface that is orthogonal to the normal and corner surfaces having profiles that are not orthogonal to the normal. The optical enhancement structure is a single structure for changing the normal angle of the first light emerging surface to increase light output efficiency. The optical enhancement structure have an optical characteristic that directs diverging light from the light emitting element along a path within the optical enhancement structure in a direction towards a normal of the pixel.

### CROSS REFERENCE TO RELATED APPLICATIONS

This application claims priority and is a continuation-in-part of pending U.S. patent application Ser. No. 10/939,017, filed on Sep. 9, 2004 and pending U.S. patent application Ser. No. 10/938,928, filed on Sep. 9, 2004. These applications are fully incorporated by reference as if fully set forth herein.

### BACKGROUND OF THE INVENTION

1. Field of the Invention

The present invention relates to light emitting devices, and more particularly to an organic light emitting device including an optical enhancement structure.

2. Description of the Related Art

Light output efficiency in conventional organic light emitting devices (OLED) and polymer light emitting devices (PLED) is insufficient due to total internal reflection (TIR) and the waveguide effect. Therefore, the actual light output efficiency is still very low although the internal quantum efficiency is near 100%.

FIG. 2 is a cross-section of a conventional organic light emitting device, only showing a pixel P₁ region for simplicity. The pixel P₁ includes a substrate 10, a reflective anode 20 formed on the substrate 10, an organic light emitting layer 22 formed on the reflective anode 20, a transparent cathode 24 formed on the organic light emitting layer 22, and a passivation layer 900 formed on the transparent cathode 24. As shown in FIG. 2, light beam L₁, emitted from the edge of the organic light emitting layer 22, reaches the boundary 901 of the pixel P₁ and cannot successfully emerge from the front of the device as useful light output.

FIG. 3 is a cross-section of a conventional organic light emitting device, only showing a pixel region for simplicity. The pixel includes a substrate 10, a reflective anode 20 formed on the substrate 10, an organic light emitting layer. 22 formed on the reflective anode 20, a transparent cathode 24 formed on the organic light emitting layer 22, and a passivation layer 900 formed on the transparent cathode 24. This conventional pixel does not add an optical enhancement structure as in the present invention. As shown in FIG. 3, when the light beam L₁, emitted from the edge of the organic light emitting layer 22, reaches the interface between the passivation layer 900 and the air, if the incident angle θ₁ exceeds the critical angle, total reflection occurs and the totally-reflected light beam is referred to as Lₜ.

Möller et al. use hemispherical micro-lens arrays to enhance light output efficiency of an OLED (J. of Appl. Phys., Vol. 91, No. 5, pp.3324-3327, 2002). FIG. 1 shows a cross-section of a pixel of an OLED designed by Möller. Label 100 indicates a glass substrate, 200 a transparent anode, 220 an organic light emitting layer, 240 an opaque cathode, and 300 a hemispherical micro-lens array. The light output efficiency, however, is still not adequate with this more complex structure. By means of the complicated interface of the hemispherical micro-lens, light output angle changes. Thus, while light output efficiency is enhanced, the enhancement is not high enough.

### SUMMARY OF THE INVENTION

The present invention solves the above-mentioned problems and provides a light emitting device with high light output efficiency. The present invention places a specially-designed optical enhancement structure along light output pathway of the light emitting device. By means of the special profile of the optical enhancement structure, the total internal reflection effect is reduced, thus enhancing light output efficiency of the organic light emitting device.

In one aspect of the present-invention, the light emerging surface of the optical enhancement structure is provided with a surface profile that reduces internal reflection. In one embodiment, the light emerging surface includes a central surface that is orthogonal to the normal and corner surfaces having profiles that are not orthogonal to the normal. The corner surface profiles may be at least one of an arcuate profile, a faceted profile, and a beveled profile. In another embodiment, light emerging surface include a convex surface, which may be an arcuate profile extending across the light emerging surface.

The optical enhancement structure may also serve additional functions, such as passivation of underlying layers, in addition to enhancing the light output. In other words, the optical enhancement layer could be combined with other layers such as the passivation layer, cathode layers, etc.

In one embodiment of the present invention, the light emitting device includes a plurality of pixels, each including a first electrode; an organic light emitting layer formed on the first electrode; a second electrode formed on the organic light emitting layer; and a first optical enhancement structure formed on the second electrode, such that light emitted from the organic light emitting layer can pass through the first optical enhancement structure and emerge from a first light emerging surface of the first optical enhancement structure. The first optical enhancement structure is a single structure for changing the normal angle of the first light emerging surface to increase light output efficiency.

According to another embodiment of the present invention, the organic light emitting device includes a plurality of pixels, each including a first electrode; an organic light emitting layer formed on the first electrode; a second electrode formed on the organic light emitting layer; and a first optical enhancement structure formed on the second electrode, such that light emitted from the organic light emitting layer can pass through the first optical enhancement structure and emerge from a first light emerging surface of the first optical enhancement structure. The first light emerging surface is an arced surface, a surface composed of a plurality of connecting slanted surfaces with gradually changed slopes, or a combination thereof.

According to a further embodiment of the present invention, the organic light emitting device includes a plurality of pixels, each including a first electrode; an organic light emitting layer formed on the first electrode; a second electrode formed on the organic light emitting layer; and a first optical enhancement structure formed on the second electrode, such that light emitted from the organic light emitting layer can pass through the first optical enhancement structure and emerge from a first light emerging surface of the first optical enhancement structure. The first light emerging surface includes a first surface and a second surface. The first surface has a flat or arced profile, and the second surface is on the sides of the first surface and is an arced surface, a slanted surface, or a surface composed of a plurality of connecting slanted surfaces with gradually changed slopes.

In another aspect, the present invention uses an optical enhancement structure that directs diverging light from the light emitting layer along a path within the optical enhancement structure towards closer to the normal to emerge more light from the pixel to improve light output efficiency. The optical enhancement structure bends diverging light from the light emitting layer along a path within the optical enhancement structure, towards the normal of the pixel. In one embodiment, this may be accomplished with an optical enhancement structure having a refractive index profile that bends the diverging light from the light emitting layer towards the normal of the pixel. In another embodiment, the optical enhancement structure is structured with gradually changing refractive indices along the light output pathway of the organic light emitting device. The refractive indices decrease through the optical enhancement structure, towards the direction in which light emerges. The optical enhancement structure may be a single monolithic layer having a refractive index gradient, or comprise several layers of materials having different refractive indices. The optical enhancement structure may also serve additional functions, such as passivation of underlying layers, in addition to enhancing the light output. In other words, the optical enhancement structure could be combined with other layers such as passivation layer, cathode layers, etc. Thus, by diffracting light towards the normal of the pixel, more of the diverging light from the light emitting layer is directed to emerge from the pixel, thus enhancing light output efficiency.

In a particular embodiment, the light emitting device includes a plurality of pixels, each pixel including a first electrode; a light emitting layer formed on the first electrode; and a second electrode formed on the organic light emitting layer. In one embodiment of the present invention, the light emitting device includes an optical enhancement structure formed on the second electrode, such that light emitted from the organic light emitting layer can pass through and emerge from the optical enhancement structure. In one embodiment of the present invention, the optical enhancement structure includes at least two optical enhancement layers consecutively disposed on the passivation layer and having different refractive indices than a refractive index of the passivation layer. In another embodiment, each consecutively disposed optical enhancement layer has a lower refractive index than the passivation layer and a preceding optical enhancement layer.

In another aspect of the present invention, the optical enhancement layer further includes a light emerging surface having features for minimizing total reflection of light. In one embodiment, the light emerging surface includes an arcuate profile, a faceted profile, or a beveled profile.

### BRIEF DESCRIPTION OF THE DRAWINGS

FIG. 1 is a cross-section of a pixel of a conventional organic light emitting device with hemispherical micro-lens arrays.

FIG. 2 is a cross-section of a conventional organic light emitting device without an optical enhancement structure.

FIG. 3 is a cross-section of a pixel of another conventional organic light emitting device without an optical enhancement structure.

FIG. 4 is a cross-section of a pixel of an organic light emitting device according to a first embodiment of a first aspect of the present invention.

FIG. 5 is a cross-section of a pixel of an organic light emitting device according to a second embodiment of the present invention.

FIG. 6 is a cross-section of a pixel of an organic light emitting device according to a third embodiment of the present invention.

FIG. 7 is a cross-section of a pixel of an organic light emitting device according to a fourth embodiment of the present invention.

FIG. 8 is a cross-section of a pixel of an organic light emitting device according to a fifth embodiment of the present invention.

FIG. 9 is a cross-section of a pixel of an organic light emitting device according to a sixth embodiment of the present invention.

FIG. 10 is a cross-section of a pixel of an organic light emitting device according to a seventh embodiment of the present invention.

FIG. 11 is a cross-section of a pixel of an organic light emitting device according to an eighth embodiment of the present invention.

FIG. 12 is a cross-section of a pixel of an organic light emitting device according to a ninth embodiment of the present invention.

FIG. 13 is a cross-section of a pixel of an organic light emitting device according to a tenth embodiment of the present invention.

FIG. 14 is a cross-section of a pixel of an organic light emitting device according to an eleventh embodiment of the present invention.

FIG. 15 is a cross-section of a pixel of an organic light emitting device according to a twelfth embodiment of the present invention.

FIG. 16 is a cross-section of a pixel of conventional organic light emitting device with hemispherical micro-lens arrays.

FIG. 17 is a schematic diagram illustrating a light emitting display device of the present invention, incorporating a controller.

FIG. 18 is a schematic diagram illustrating an electronic device, incorporating the light emitting display device of the present invention.

FIG. 19 is a cross-section of an organic light emitting device according to a first embodiment of another aspect of the present invention.

FIG. 20 is a cross-section of an organic light emitting device according to a second embodiment of the present invention.

FIG. 21 is a cross-section of an organic light emitting device according to a third embodiment of the present invention.

FIG. 22 is a cross-section of an organic light emitting device according to a fourth embodiment of the present invention.

FIG. 23 is a cross-section of an organic light emitting device according to a fifth embodiment of the present invention.

FIG. 24 is a cross-section of an organic light emitting device according to a sixth embodiment of the present invention.

FIG. 25 is a cross-section of an organic light emitting device according to a seventh embodiment of the present invention.

FIG. 26 shows a basic structure of a pixel of an organic light emitting device of the present invention.

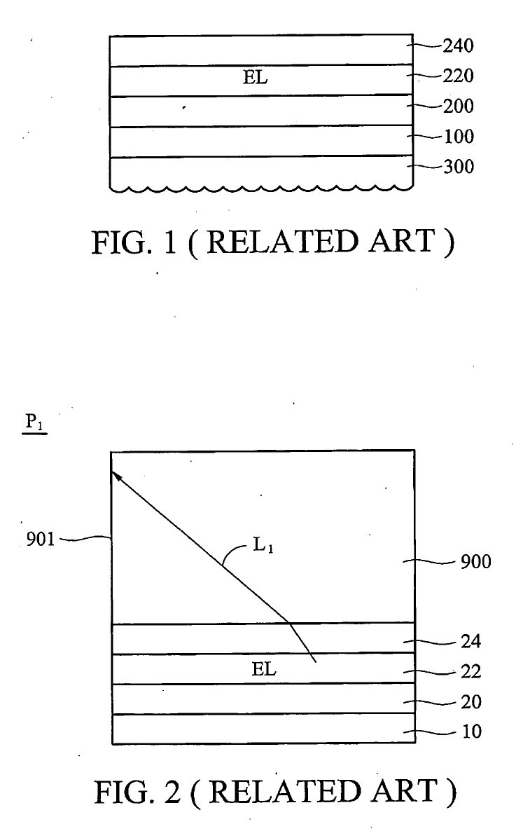

### DETAILED DESCRIPTION OF THE INVENTION

The present invention will be described below in connection with organic light emitting devices, to illustrate the general principle of the present invention. However, it is understood that the present invention is not limited to organic light emitting devices. Other types of light emitting devices can also take advantage of the present invention within the scope and spirit of the present invention.

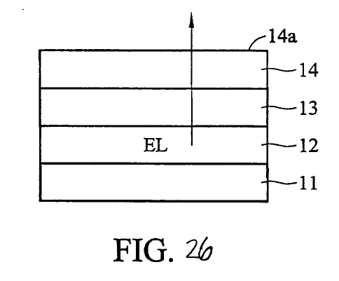

FIG. 26 is a cross-section view illustrating an organic light emitting device according to a first embodiment of the present invention. For the sake of simplicity, FIG. 26 only shows a pixel region of the organic light emitting device. Further, there may be additional elements or components that are not shown in FIG. 26 but which may be present in the organic light emitting device.

Referring to FIG. 26, the pixel of the organic light emitting device includes a first electrode 11 formed on a glass substrate (not shown), an organic light emitting layer 12 formed on the first electrode 11, a second electrode 13 formed on the organic light emitting layer 12, and a first optical enhancement structure 14 formed on the second electrode 13. Light emitted from the organic light emitting layer 12 can pass through the first optical enhancement structure 14 and emerge from a first light emerging surface 14 a of the first optical enhancement structure 14. The first optical enhancement structure 14 is a single structure and can reduce total internal reflection effect.

FIG. 4 is a cross-section of a pixel of an organic light emitting device according to a first embodiment of a first aspect of the present invention. The pixel includes a substrate 10, a reflective anode 20 formed on the substrate 10, an organic light emitting layer 22 formed on the reflective anode 20, a transparent cathode 24 formed on the organic light emitting layer 22, a passivation layer 26 formed on the transparent cathode 24, and a first optical enhancement structure 30 formed on the passivation layer 26.

The first optical enhancement structure 30 includes a first light emerging surface 31 and a bottom surface 32. The first light emerging surface 31 further includes a first surface 311 and a second surface 312. The first surface 311 has a flat profile. The second surface 312 is on the sides of the first surface 311 to connect with the bottom surface 32 and has an arced profile. Alternatively, the second surface 312 can be composed of a plurality of connecting slanted surfaces with gradually changed slopes.

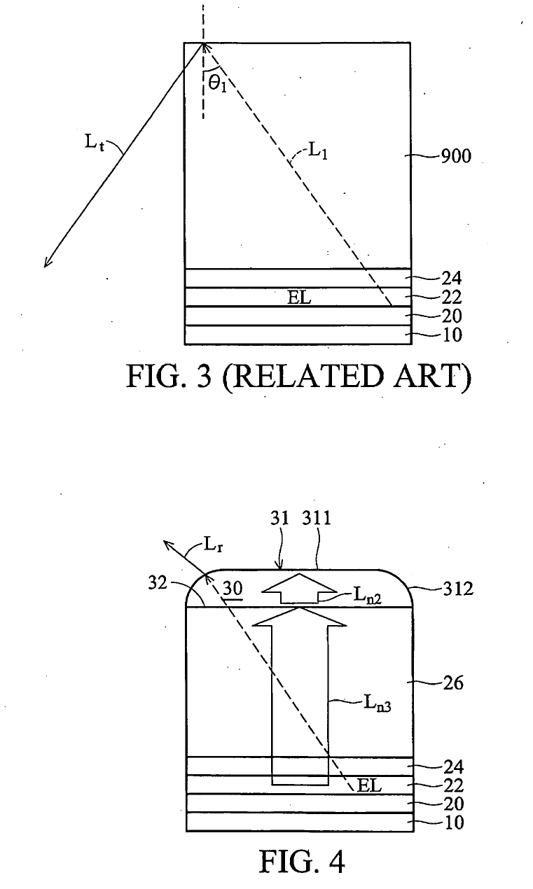

As shown in FIG. 4, when the light beam Lₙ₃ (the same location as in conventional FIG. 3), emitted from the edge of the organic light emitting, layer 22, converges by the first optical enhancement layer 30 and successfully through the first optical enhancement layer 30 as the light beam Lₙ₂. Light beam reaches the second surface 312 of the first optical enhancement layer 30. Since the second surface 312 has an arcuate profile, the incident angle of the light beam is decreased to not exceed the critical angle. Thus, light beam will not be totally reflected but refract and emerge as the light beam Lᵣ. That is to say, the light beam that is otherwise totally reflected can refract and emerge by means of the second surface 312 of the first optical enhancement layer 30 of the present invention, thus further increasing light output efficiency.

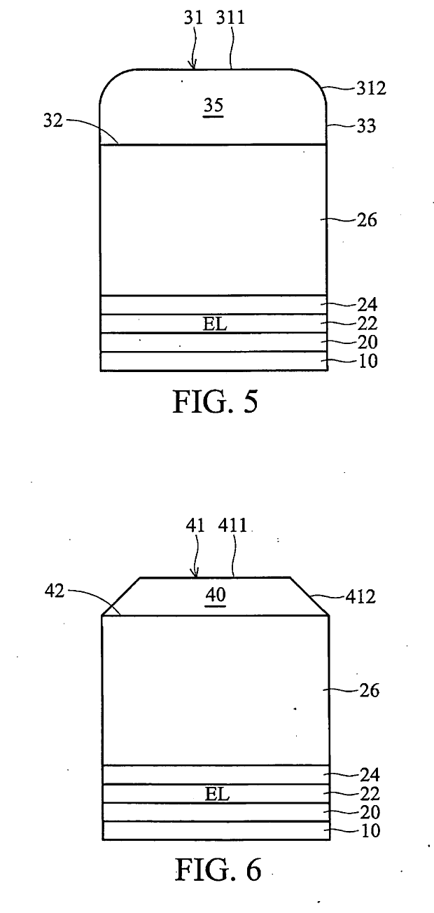

FIG. 5 is a cross-section of an organic light emitting device according to a second embodiment of the present invention. The pixel includes a substrate 10, a reflective anode 20, an organic light emitting layer 22, a transparent cathode 24, and a passivation layer 26. Corresponding elements are the same as in FIG. 4 and detailed descriptions are thus omitted here. FIG. 5 differs from FIG. 4 in the first optical enhancement structure. In FIG. 5, the first optical enhancement structure 35 is formed on the passivation layer 26 and has a first light emerging surface 31, a bottom surface 32, and a sidewall 33. The first light emerging surface 31 includes a first surface 311 and a second surface 312. The first surface 311 has a flat profile, and the second surface 312 has an arcuate profile and is on the sides of the first surface 311. The second surface 312 connects the bottom surface 32 with the sidewall 33.

Similar to FIG. 4, the light beam totally reflected in the conventional OLED can refract and emerge by means of the optical enhancement structure 35 in FIG. 5 of the present invention, thus increasing light output efficiency.

FIG. 6 is a cross-section of an organic light emitting device according to a third embodiment of the present invention. The pixel includes a substrate 10, a reflective anode 20, an organic light emitting layer 22, a transparent cathode 24, and a passivation layer 26. Corresponding elements are the same as in FIG. 4 and detailed descriptions are thus omitted here. FIG. 6 differs from FIG. 4 in the first optical enhancement structure. In FIG. 6, the first optical enhancement structure 40 is formed on the passivation layer 26 and has a first light emerging surface 41 and a bottom surface 42. The first light emerging surface 41 includes a first surface 411 and a second surface 412. The first surface 411 has a flat profile, and the second surface 412 has a slanted or faceted profile and is on the sides of the first surface 411 to connect the bottom surface 42.

Similar to FIG. 4, the light beam on the edge that is totally reflected originally no longer satisfies the total reflection condition by means of the slanted profile of the second surface 412. Thus, the light beam on the edge refracts and emerges, such that light output efficiency is enhanced.

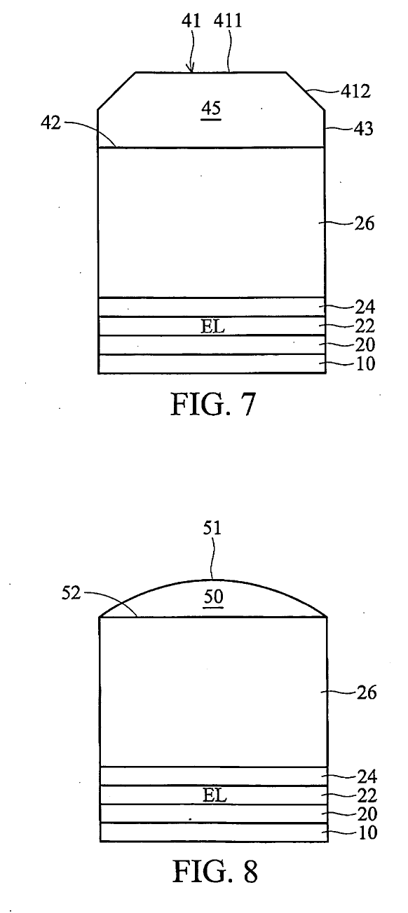

FIG. 7 is a cross-section of organic light emitting device according to a fourth embodiment of the present invention. The pixel includes a substrate 10, a reflective anode 20, an organic light emitting layer 22, a transparent cathode 24, and a passivation layer 26. Corresponding elements are the same as in FIG. 4 and detailed descriptions are thus omitted here. FIG. 7 differs from FIG. 4 in the first optical enhancement structure. In FIG. 7, the first optical enhancement structure 45 is formed on the passivation layer 26 and has a first light emerging surface 41, a bottom surface 42, and a sidewall 43. The first light emerging surface 41 includes a first surface 411 and a second surface 412. The first surface 411 has a flat profile, and the second surface 412 has a slanted or faceted profile and is on the sides of the first surface 411. The second surface 412 connects the bottom surface 42 with the sidewall 43.

Similar to FIG. 6, since the second surface 412 has a slanted profile, the light beam on the edge that is totally reflected originally no longer satisfies the total reflection condition because of the presence of the first optical enhancement structure 45. Thus, the light beam on the edge refracts and emerges, such that light output efficiency is enhanced.

FIG. 8 is a cross-section of an organic light emitting device according to a fifth embodiment of the present invention. The pixel includes a substrate 10, a reflective anode 20, an organic light emitting layer 22, a transparent cathode 24, and a passivation layer 26. Corresponding elements are the same as in FIG. 4 and detailed descriptions are thus omitted here. FIG. 8 differs from FIG. 4 in the first optical enhancement structure. In FIG. 8, the first optical enhancement structure 50 has a first light emerging surface 51 and a bottom surface 52. The first light emerging surface 51 has an arced profile.

Similar to FIG. 4, the light beam on the edge that is totally reflected originally no longer satisfies the total reflection condition because of the presence of the arced profile of the first light emerging surface 51. Thus, the light beam on the edge refracts and emerges, such that light output efficiency is enhanced.

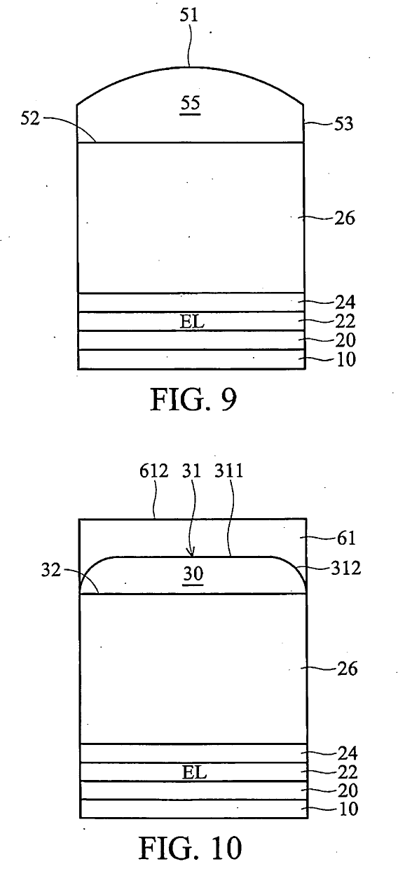

FIG. 9 is a cross-section of an organic light emitting device according to a sixth embodiment of the present invention. The pixel includes a substrate 10, a reflective anode 20, an organic light emitting layer 22, a transparent cathode 24, and a passivation layer 26. Corresponding elements are the same as in FIG. 4 and detailed descriptions are thus omitted here. FIG. 9 differs from FIG. 4 in the first optical enhancement structure. In FIG. 9, the first optical enhancement structure 55 is formed on the passivation layer 26 and has a first light emerging surface 51, a bottom surface 52, and a sidewall 53. The first light emerging surface 51 has an arced profile and connects the bottom surface 52 with the sidewall 53.

Similar to FIG. 8, the light beam on the edge that is totally reflected originally no longer satisfies the total reflection condition because of the presence of the arced profile of the first light emerging surface 51. Thus, the light beam on the edge refracts and emerges, such that light output efficiency is enhanced.

FIG. 10 is a cross-section of a pixel of an organic light emitting device according to a seventh embodiment of the present invention. Referring to FIGS. 4 and 10, FIG. 10 differs from FIG. 4 in that a second optical enhancement structure 61 is additionally disposed on the first optical enhancement structure 30. The second optical enhancement structure 61 adheres to the first optical enhancement structure 30 to constitute a doublet lens. Thus, light emitted from the organic light emitting layer 22 can sequentially pass through the first and second optical enhancement structures 30 and 61 and emerge from a second light emerging surface 612 of the second optical enhancement structure 61. The refractive index sequence (from large to small) is the passivation layer 26, the first optical enhancement structure 30, and the second optical enhancement structure 61.

Similar to FIG. 4, the light beam on the edge that is totally reflected originally no longer satisfies the total reflection condition because of the presence of the arced profile of the second surface 312 of the first optical enhancement structure 30. Thus, the light beam on the edge refracts and emerges, such that light output efficiency is enhanced.

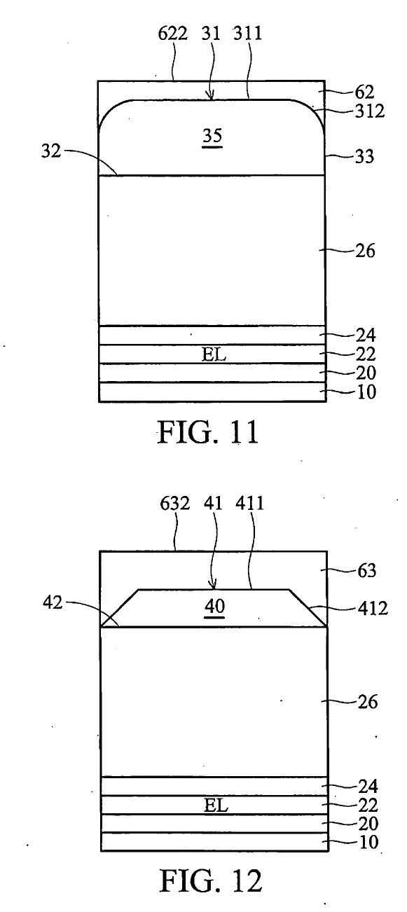

FIG. 11 is a cross-section of an organic light emitting device according to an eighth embodiment of the present invention. Referring to FIGS. 5 and 11, FIG. 11 differs from FIG. 5 in that a second optical enhancement structure 62 is additionally disposed on the first optical enhancement structure 35. Thus, light emitted from the organic light emitting layer 22 can sequentially pass through the first and second optical enhancement structures 35 and 62 and emerge from a second light emerging surface 622 of the second optical enhancement structure 62. The refractive index sequence (from large to small) is the passivation layer 26, the first optical enhancement structure 35, and the second optical enhancement structure 62.

Similar to FIG. 5, the light beam on the edge that is totally reflected originally no longer satisfies the total reflection condition because of the presence of the arced profile of the second surface 312 of the first optical enhancement structure 35. Thus, the light beam on the edge refracts and emerges, such that light output efficiency is enhanced.

FIG. 12 is a cross-section of an organic light emitting device according to a ninth embodiment of the present invention. Referring to FIGS. 6 and 12, FIG. 12 differs from FIG. 6 in that a second optical enhancement structure 63 is additionally disposed on the first optical enhancement structure 40. Thus, light emitted from the organic light emitting layer 22 can sequentially pass through the first and second optical enhancement structures 40 and 63 and emerge from a second light emerging surface 632 of the second optical enhancement structure 63. The refractive index sequence (from large to small) is the passivation layer 26, the first optical enhancement structure 40, and the second optical enhancement structure 63.

Similar to FIG. 6, the light beam on the edge that is totally reflected originally no longer satisfies the total reflection condition because of the presence of the slanted profile of the second surface 412 of the first optical enhancement structure 40. Thus, the light beam on the edge refracts and emerges, such that light output efficiency is enhanced.

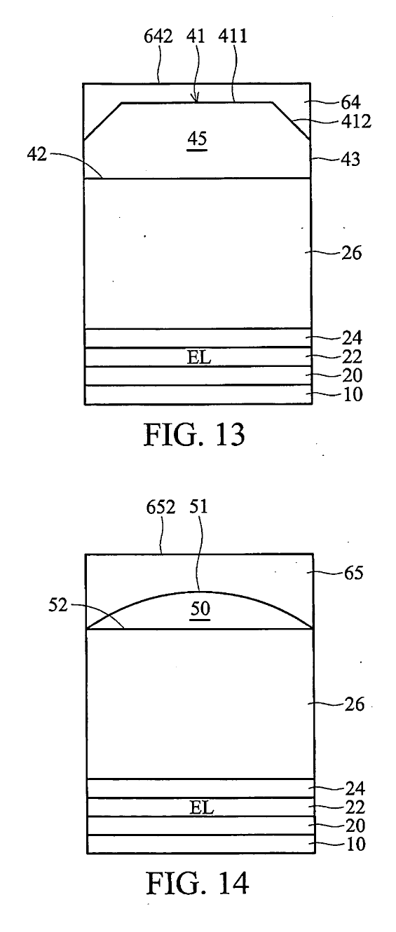

FIG. 13 is a cross-section of an organic light emitting device according to a tenth embodiment of the present invention. Referring to FIGS. 7 and 13, FIG. 13 differs from FIG; 7 in that a second optical enhancement structure 64 is additionally disposed on the first optical enhancement structure 45. Thus, light emitted from the organic light emitting layer 22 can sequentially pass through the first and second optical enhancement structures 45 and 64 and emerge from a second light emerging surface 642 of the second optical enhancement structure 64. The refractive index sequence (from large to small) is the passivation layer 26, the first optical enhancement structure 45, and the second optical enhancement structure 64.

Similar to FIG. 7, the light beam on the edge that is totally reflected originally no longer satisfies the total reflection condition because of the presence of the slanted profile of the second surface 412 of the first optical enhancement structure 45. Thus, the light beam on the edge refracts and emerges, such that light output efficiency is enhanced.

FIG. 14 is a cross-section of an organic light emitting device according to an eleventh embodiment of the present invention. Referring to FIGS. 8 and 14, FIG. 14 differs from FIG. 8 in that a second optical enhancement structure 65 is additionally disposed on the first optical enhancement structure 50. Thus, light emitted from the organic light emitting layer 22 can sequentially pass through the first and second optical enhancement structures 50 and 65 and emerge from a second light emerging surface 652 of the second optical enhancement structure 65. The refractive index sequence (from large to small) is the passivation layer 26, the first optical enhancement structure 50, and the second optical enhancement structure 65.

Similar to FIG. 8, the light beam on the edge that is totally reflected originally no longer satisfies the total reflection condition because of the presence of the arced profile of the first light emerging surface 51 of the first optical enhancement structure 50. Thus, the light beam on the edge refracts and emerges, such that light output efficiency is enhanced.

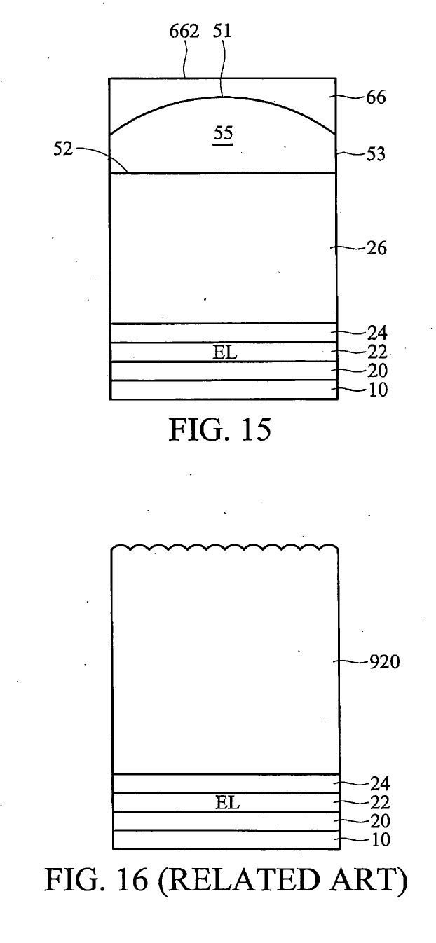

FIG. 15 is a cross-section of an organic light emitting device according to a twelfth embodiment of the present invention. Referring to FIGS. 9 and 15, FIG. 15 differs from FIG. 9 in that a second optical enhancement structure 66 is additionally disposed on the first optical enhancement structure 55. Thus, light emitted from the organic light emitting layer 22 can sequentially pass through the first and second optical enhancement structures 55 and 66 and emerge from a second light emerging surface 662 of the second optical enhancement structure 66. The refractive index sequence (from large to small) is the passivation layer 26, the first optical enhancement structure 55, and the second optical enhancement structure 66.

Similar to FIG. 9, the light beam on the edge that is totally reflected originally no longer satisfies the total reflection condition because of the presence of the arced profile of the first light emerging surface 51 of the first optical enhancement structure 55. Thus, the light beam on the edge refracts and emerges, such that light output efficiency is enhanced.

The reflective anode 20 suitable for use in the present invention can be ITO (indium-tin-oxide) or IZO (indium-zinc-oxide) combined with a reflective film or a high work function metal film. The organic light emitting layer 22 can include a hole transport layer (HTL), an emitting layer (EML) and an electron transport layer (ETL) The transparent cathode 24 can be formed by coating a transparent metal film. The passivation layer 26 can be a polymer.

The first and second optical enhancement structures can be a polymer and function to reduce total internal reflection. The first and second optical enhancement structures can be formed by coating, photolithography, and etching applied in the semiconductor process; or can be a thermoplastic formed in a mold.

Computer Simulation:

The models disclosed, of FIG. 3 (conventional), FIG. 4 (the present invention), FIG. 6 (the present invention), FIG. 8 (the present invention), FIG. 11 (the present invention), and FIG. 16 (conventional) were created by computer simulation.

The following parameters were established: reflectivity of the reflective anode 20 at 100%, organic light emitting layer 22 thickness of 0.15 μm with average refractive index of 1.75, transmittance of the transparent cathode at 100%, and pixel width 2000 μm.

FIG. 3 (conventional): the thickness of the passivation layer 900 is 1000 μm and n=1.4.

FIG. 4 (the present invention, single mesa type): the thickness of the passivation layer 26 is 1000 μm and n=1.46. The thickness of the first optical enhancement structure 30 is 275 μm and n=1.4. The first surface 311 has a width of 550 μm, and the second surface 312 has a curvature radius of 1500 μm.

FIG. 6 (the present invention, single mesa type): the thickness of the passivation layer 26 is 1000 μm and n=1.46. The thickness of the first optical enhancement structure 40 is 200 μm and n=1.4. The first surface 411 has a width of 1000 μm.

FIG. 8 (the present invention, single hemispherical type): the thickness of the passivation layer 26 is 1000 μm and n=1.46. The thickness of the first optical enhancement structure 50 is 200 μm and n=1.4. The first light emerging surface 51 has a curvature radius of 1500 μm.

FIG. 11 (the present invention, doublet lens type): the thickness of the passivation layer 26 is 700 μm and n=1.46. The thickness of the first optical enhancement structure 50 is 575 μm and n=1.4. The first surface 311 has a width of 1750 μm, and the second surface 312 has a curvature radius of 1800 μm. The second optical enhancement structure 62 has a thickness of 10 μm and n=1.3.

FIG. 16 (conventional, micro-lens type): the thickness of the passivation layer 920 is 1000 μm and n=1.4. The micro-lens array has a curvature radius of 10 μm.

The computer simulation results are shown in Table 1. It can be seen that the OLED pixel structure of the present invention greatly enhances light output efficiency.

TABLE 1

| | Optical | Light |
|---|---|---|
| | enhancement | output |
| FIG. | structure | efficiency |
| | None | 10% |
| (Conventional) | | |
| | Micro-lens type | 13% |
| (Conventional) | | |
| | Single mesa type | 19% |
| (The present invention) | | |
| | Single mesa type | 19% |
| (The present invention) | | |
| | Single | 18% |
| (The present invention) | hemispherical | |
| | type | |
| | Doublet lens | 23% |
| (The present invention) | Type | |

In conclusion, the first aspect of the present invention disposes an optical enhancement structure with special design in light output pathway of the organic light emitting device. Thus, the total reflection effect is reduced and light output efficiency is greatly enhanced.

FIG. 19 is a cross-section view illustrating an organic light emitting device according to a first embodiment of a second aspect of the present invention. For the sake of simplicity, FIG. 19 only shows a pixel region P₁₀ of the organic light emitting device. Further, there may be additional elements or components that are not shown in FIG. 19 but which may be present in the organic light emitting device.

Referring to FIG. 19, the pixel P₁₀ of the organic light emitting device includes a substrate 10, a reflective anode 20 formed on the substrate 10, an organic light emitting layer 22 formed on the reflective anode 20, a transparent cathode 24 formed on the organic light emitting layer 22, a passivation layer 26 formed on the transparent cathode 24, and an optical enhancement structure S formed on the passivation layer 26. The passivation layer 26 is optically coupled to the light emitting layer 22 and has a refractive index. The optical enhancement structure S includes a plurality of optical enhancement layers. For example, the optical enhancement structure S includes a first or inner optical enhancement layer 30 disposed on the passivation layer 26, and a second or outer optical enhancement layer 140 disposed on the first optical enhancement layer 130. The plurality of optical enhancement layers are optically coupled to the light emitting layer. The passivation layer and the plurality of optical enhancement layers are configured such that the refractive indices of these layers are in decreasing order from the passivation layer to the outer optical enhancement layer. In other words, the refractive index n2 of the first optical enhancement layer 130 is lower than the refractive index n3 of the passivation layer 26, while the refractive index n1 of the second optical enhancement layer 140 is lower than the refractive index n2 of the first optical enhancement layer 130.

The light emitting device of this embodiment of the present invention is configured such that the passivation layer 26 (FIG. 19) is thinner than the conventional passivation layer 900 (FIG. 2), and the total thickness of the passivation layer 26 and the optical enhancement structure S of the present invention can be kept approximately equal to or less than the thickness of the conventional passivation layer 900. Thus the present invention does not necessarily increase the thickness of the overall structure.

For example, the conventional passivation layer 900 is about 1000 μm thick, the passivation layer 26 of the present invention is about 700 μm thick, and the first and second optical enhancement layers 130 and 140 are about 150 μm each. Thus, light beam Lₙ₃ (as shown in FIG. 19.), emitted from the organic light emitting layer 22, converges by the first and second optical enhancement layers 130 and 140 and successfully through the first and the second optical enhancement layers 130 and 140 as the light beam Lₙ₂ and Lₙ₁. That is, by passing through different media (i.e., layers 26, 130 and 140 with differing refractive indices n3, n2, and n1 to form a refractive index gradient in the optical enhancement structure S), light is converged and intensified, therefore, a portion of light that was originally blocked can emerge, thus enhancing light output efficiency.

As is illustrated by the foregoing embodiment, the present invention uses an optical enhancement structure that directs diverging light from the light emitting layer along a path within the optical enhancement structure towards closer to the normal to emerge more light from the pixel to improve light output efficiency. In one aspect of the invention, the optical enhancement structure bends diverging light from the light emitting layer along a path within the optical enhancement structure towards the normal of the pixel. In one embodiment, this may be accomplished with an optical enhancement structure having a refractive index profile that bends the diverging light from the light emitting layer towards the normal of the pixel. In another embodiment, the optical enhancement structure is structured with gradually changing refractive indices along the light output pathway of the organic light emitting device. The refractive indices decrease through the optical enhancement structure, towards the direction in which light emerges. The optical enhancement structure may be a single monolithic layer having a refractive index gradient, or as illustrated in the embodiment of FIG. 19, comprises several layers of materials having different refractive indices. The optical enhancement structure may also serve additional functions, such as passivation of underlying layers, in addition to enhancing the light output. In other words, the optical enhancement structure could be combined with other layers such as the passivation layer, cathode layers, or others.

As shown in FIG. 19, the light emerging surface 41 of the second optical enhancement layer 140 has a substantially flat or planar profile, but it is not limited to this. The light emerging surface 141 can also have a non-flat surface, such that the second optical enhancement layer 140 functions to reduce total reflection of light.

FIG. 20 is a cross-section of an organic light emitting device according to a second embodiment of the present invention, showing a non-flat light emerging surface. The pixel includes a substrate 10, a reflective anode 20, an organic light emitting layer 22, a transparent cathode 24, a passivation layer 26, and a first optical enhancement layer 130. Corresponding elements are the same as in FIG. 3 and detailed descriptions are thus omitted here. FIG. 20 differs from FIG. 19 in the second optical enhancement layer 40. In FIG. 20, the second optical enhancement layer 140 is a total reflection-reducing layer and includes a light emerging surface 141 and a bottom surface 142. The light emerging surface 141 includes first and second surfaces 1411 and 1412. The first surface 1411 has a substantially flat profile, and the second surface 1412 has an arcuate profile on each boundary of the first surface 1411 to connect with the bottom surface 142. The arcuate profile of the second surface 1412 can be smooth or be composed of a plurality of connecting faceted surfaces with gradually changed slopes.

As shown in FIG. 20, light beam Lₙ₃ is emitted from the organic light emitting layer 22 through the first and the second optical enhancement layers 130 and 140 as the light beam Lₙ₂ and Lₙ₁ and light beam Lₙ₂ reaches the second surface 1412 of the second optical enhancement layer 140. Since the second surface 1412 has an arcuate profile, the incident angle of the light beam Lₙ₂ is decreased to not exceed the critical angle. Thus, light beam Lₙ₂ will not be totally reflected but refract and emerge as the light beam Lₙ₃. That is to say, the light beam that is otherwise totally reflected can refract and emerge by means of the second surface 1412 of the second optical enhancement layer 140 of the present invention, thus further increasing light output efficiency.

The configuration of the light emitting device shown in FIG. 4 facilitates light output efficiency. The passivation layer 26 is made thinner than the conventional passivation layer, and the refractive indices of the passivation layer and the two optical enhancement layers 130 and 140 are in gradual decreasing order. As a result, a light beam originally blocked by the boundary of the passivation layer can successfully emerge by the changed light pathway. Since the second surface 1412 has an arcuate profile, light beam is no longer totally reflected and is able to emerge.

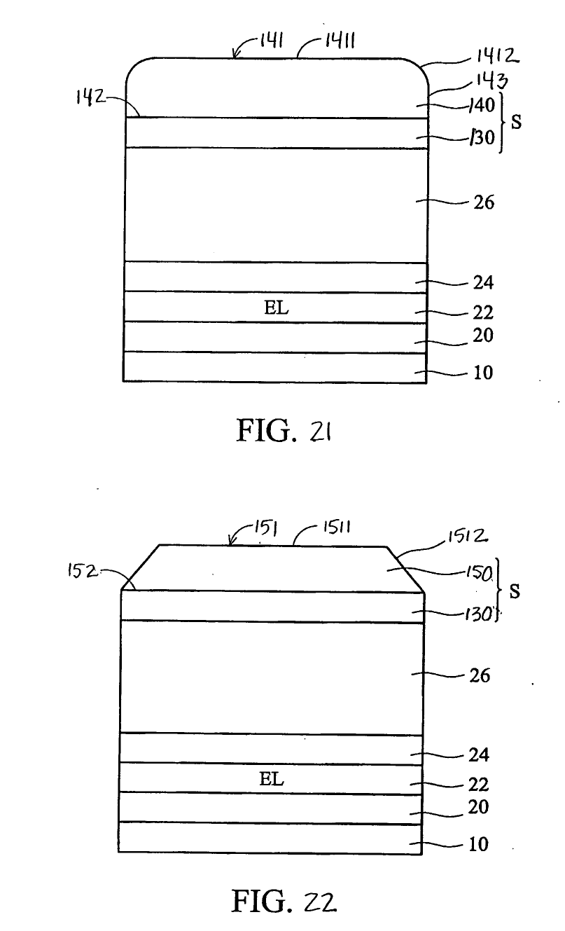

FIG. 21 is a cross-section of an organic light emitting device according to a third embodiment of the present invention. The pixel includes a substrate 10, a reflective anode 20, an organic light emitting layer 22, a transparent cathode 24, and a passivation layer 26. Corresponding elements are the same as in FIG. 19 and detailed descriptions are thus omitted here. FIG. 21 differs from FIG. 19 in the second optical enhancement layer 140. In FIG. 21, the second optical enhancement layer 140 is a total reflection-reducing layer and has a light emerging surface 141, a bottom surface 142, and a boundary 143. The light emerging surface 141 includes first and second surfaces 1411 and 1412. The first surface 1411 has a substantially flat profile, and the second surface 1412 has an arcuate profile on each side of the first surface 1411. The second surface 1412 connects the bottom surface 142 with the boundary 143.

Similar to FIG. 4, the passivation layer 26 is made thinner than the conventional passivation layer, and the refractive indices of the passivation layer and the two optical enhancement layers 130 and 140 are in gradual decreasing order. As a result, a light beam originally blocked by the boundary of the passivation layer can successfully emerge by the changed light pathway. Since the second surface 1412 has an arcuate profile, light beam is no longer totally reflected and is able to emerge.

FIG. 22 is a cross-section of an organic light emitting device according to a fourth embodiment of the present invention. The pixel includes a substrate 10, a reflective anode 20, an organic light emitting layer 22, a transparent cathode 24, and a passivation layer 26. Corresponding elements are the same as in FIG. 19 and detailed descriptions are thus omitted here. FIG. 22 differs from FIG. 19 in the second optical enhancement layer. In FIG. 22, the optical enhancement structure S includes first and second optical enhancement layers 130 and 150. The second optical layer 150 is a total reflection-reducing layer and includes a light emerging surface 151 and a bottom surface 152. The light emerging surface 151 includes first and second surfaces 1511 and 1512. The first surface 1511 has a substantially flat profile, and the second surface 1512 has a slanted or faceted profile and is disposed on the sides of the first surface 1511 to connect with the bottom surface 152.

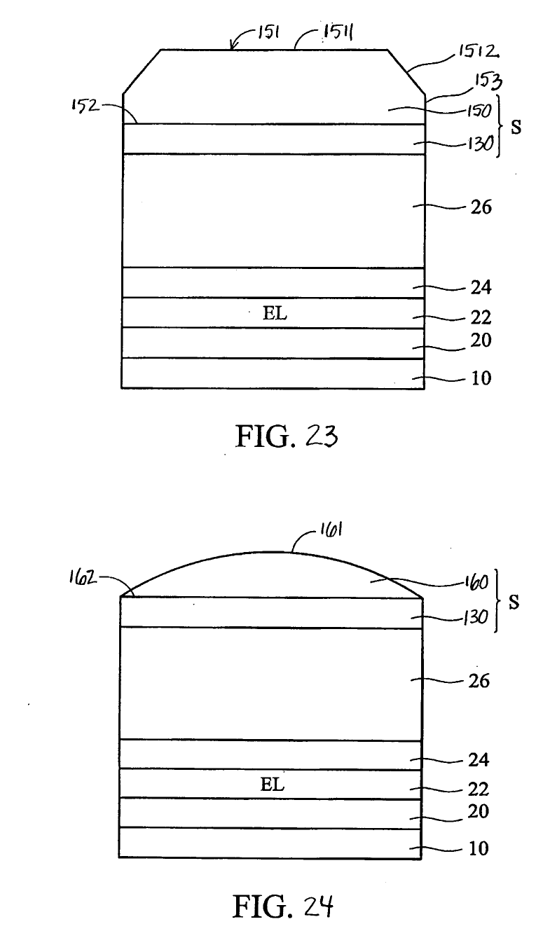

FIG. 23 is a cross-section of an organic light emitting device according to a fifth embodiment of the present invention. The pixel includes a substrate 10, a reflective anode 20, an organic light emitting layer 22, a transparent cathode 24, and a passivation layer 26. Corresponding elements are the same as in FIG. 19 and detailed descriptions are thus omitted here. FIG. 23 differs from FIG. 19 in the second optical enhancement layer. In FIG. 23, the optical enhancement structure S includes a first optical enhancement layer 130 and a second optical enhancement layer 150. The second optical enhancement layer 150 is a total reflection-reducing layer and includes a light emerging surface 151, a bottom surface 152, and a boundary 153. The light emerging surface 151 includes a first surface 1511 and a second surface 1512. The first surface 1511 has a substantially flat profile, and the second surface 1512 has a slanted or faceted profile and is on the sides of the first surface 1511. The second surface 1512 connects the bottom surface 152.

FIG. 24 is a cross-section of an organic light emitting device according to a sixth embodiment of the present invention. The pixel includes a substrate 10, a reflective anode 20, an organic light emitting layer 22, a transparent cathode 24, and a passivation layer 26. Corresponding elements are the same as in FIG. 19 and detailed descriptions are thus omitted here. FIG. 24 differs from FIG. 19 in the second optical enhancement layer. In FIG. 24, the optical enhancement structure S includes a first optical enhancement layer 130 and a second optical enhancement layer 160. The second optical enhancement layer 160 is a total reflection-reducing layer and has a light emerging surface 161 and a bottom surface 162. FIG. 24 shows that the light emerging surface 161 has an arcuate profile.

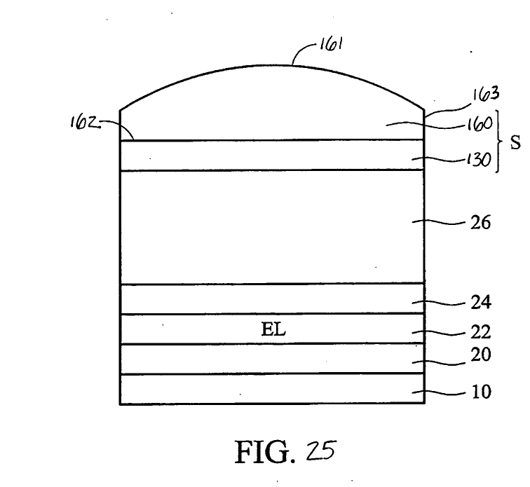

FIG. 25 is a cross-section of an organic light emitting device according to a seventh embodiment of the present invention. The pixel includes a substrate 10, a reflective anode 20, an organic light emitting layer 22, a transparent cathode 24, and a passivation layer 26. Corresponding elements are the same as in FIG. 19 and detailed descriptions are thus omitted here. FIG. 25 differs from FIG. 19 in the second optical enhancement layer. In FIG. 25, the optical enhancement structure S includes a first optical enhancement layer 130 and a second optical enhancement layer 160. The second optical enhancement layer 160 is a total reflection-reducing layer and has a light emerging surface 161, a bottom surface 162, and a boundary 163. The light emerging surface 161 connects the bottom surface 162 with the boundary 163. The light emerging surface 161 has an arcuate profile.

In all the above embodiments of the present invention, the optical enhancement structure includes two optical enhancement layers as an example, but it is not limited to this. The optical enhancement structure of the present invention can include multiple optical enhancement layers, and such as 2 to 10, preferably 2 to 5 optical enhancement layers. The optical enhancement structure of the present invention includes multiple optical enhancement layers consecutively disposed on the passivation layer, with the most inner enhancement layer having a refractive index lower than the refractive index of the passivation layer and each successively disposed enhancement layer having a lower refractive index than the refractive index of the preceding layer. That is, the optical enhancement layer closest to the passivation layer 26 has the largest refractive index, and that farthest from the passivation layer 26 has the smallest refractive index.

The reflective anode suitable for use in the present invention can be ITO (indium-tin-oxide) or IZO (indium-zinc-oxide) combined with a reflective film or a high work function metal film. The light emitting layer can be an organic light emitting layer that includes a hole transport layer (HTL), an emitting layer (EML) and an electron transport layer (ETL). The transparent cathode can be formed by coating a transparent metal film. The passivation layer can be a polymer.

Each optical enhancement layer can be a polymer and can be formed by coating, photolithography, and etching applied in the semiconductor process; or can be a thermoplastic formed in a mold.

Computer Simulation:

The models disclosed, of FIG. 2 (conventional), FIG. 19 (the present invention), and FIG. 16 (conventional) were created by computer simulation.

The following parameters were established: reflectivity of the reflective anode 20 at 100%, organic light emitting layer 22 with thickness of 0.15 μm and average refractive index of 1.75, transmittance of the transparent cathode 24 at 100%, and pixel width of 2000 μm.

Embodiment of FIG. 2 (conventional): the thickness of the passivation layer 900 is 1000 μm and n=1.4.

Embodiment of FIG. 19 (the present invention): the thickness of the passivation layer 26 is 700 μm and n=1.46. The thickness of the first optical enhancement layer 130 is 150 μm and n=1.4. The thickness of the second optical enhancement layer 140 is 150 μm and n=1.3.

Embodiment of FIG. 16 (conventional, micro-lens type): the thickness of the passivation layer 920 is 1000 μm and n=1.4. The micro-lens array has a curvature radius of 10 μm.

The computer simulation results are shown in Table 2. It can be seen that the OLED pixel structure of the present invention improves light output efficiency.

TABLE 2

| | Optical | Light |
|---|---|---|
| | enhancement | output |
| FIG. | structure | efficiency |
| | None | 10% |
| (Conventional) | | |
| | Micro-lens type | 13% |
| (Conventional) | | |
| | Two optical | 14%-16% |
| (The present invention) | enhancement layers | |

In conclusion, the light emitting device of the present invention has improved light output efficiency due to a thinner passivation layer and incorporation of at least two optical enhancement layers disposed on the passivation layer, with each successive layer from the passivation layer to the outer enhancement layer having a lower refractive index than the preceding layer. The pathway of the light beam is changed by the different media layers, allowing that light beam to emerge.

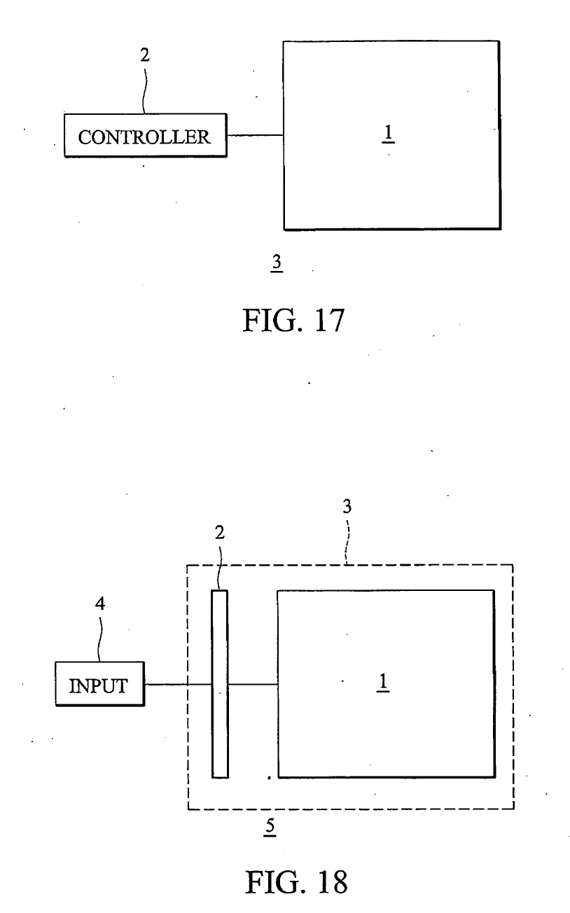

The light emitting device of the present can be coupled to a controller to form a light emitting display device. For example, the organic light emitting devices shown in FIG. 4 and FIG. 19 can be coupled to a controller 2, forming a light emitting display device 3 as shown in FIG. 17. The controller 2 can comprise a source and gate driving circuits (not shown) to control the light emitting device 1 to render image in accordance with an input. The light emitting display device 3 and associated controller 2 may be directed to an OLED type display device.

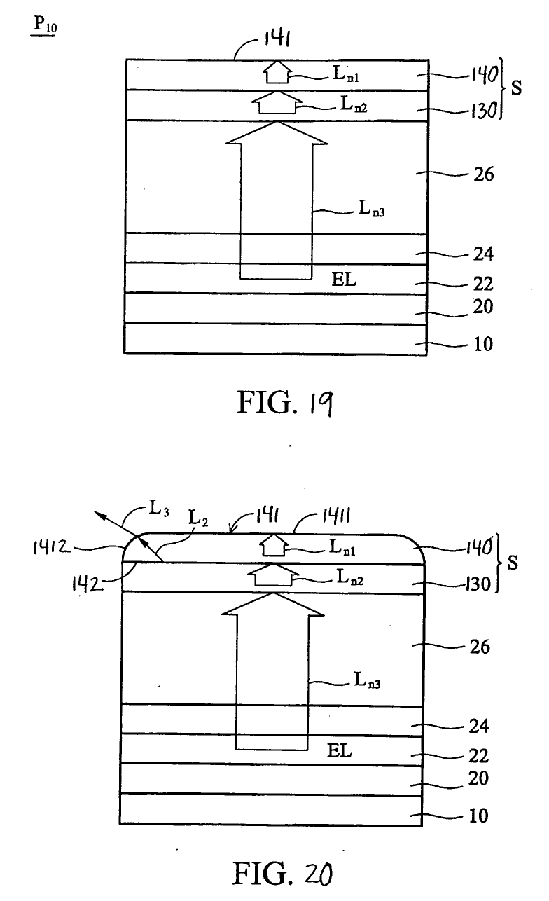

FIG. 18 is a schematic diagram illustrating an electronic device 5 incorporating the light emitting display device 3 shown in FIG. 17. An input device 4 is coupled to the controller 2 of the light emitting display device 3 shown in FIG. 17 to form an electronic device 5. The input device 4 can include a processor or the like to input data to the controller 2 to render an image. The electronic device 5 may be a portable device such as a PDA, notebook computer, tablet computer, cellular phone, or a display monitor device, or non-portable device such as a desktop computer.

Other types of light emitting devices may include PLED, plasma display panel (PDP), chemiluminescent display devices, backlit liquid crystal display devices, or the likes.

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. For example, while the invention is illustrated by way of example of the optical enhancement layer being on side of the passivation layer away from the light emitting layer, the optical enhancement layer may be deployed above the light emitting layer, either below the passivation layer, or completely omitting the passivation layer. In other words, the optical enhancement layer may also function as a passivation layer. Also the optical enhancement layer may be a single layer of material having a refractive index gradient. All such modifications and variations are within the scope of the present invention as determined by the appended claims when interpreted in accordance with the breadth to which they are fairly, legally, and equitably entitled.

What is claimed is:

1. A light emitting device having a plurality of pixels, each pixel defined by a structure comprising:
a light emitting element, wherein some of the light from the light emitting element is emitted in a diverging manner; and
an optical enhancement structure that is optically coupled to the light emitting element, said optical enhancement structure having a single convex light emerging surface that includes a flat central surface of a defined width that is orthogonal to a normal of the light emitting element, and corner surfaces contiguous to both ends of the flat central surface, wherein the corner surfaces have profiles that are not orthogonal to the normal of the light emitting element.

2. The light emitting device as in claim 1, wherein the single convex light emerging surface extends over the entire light emitting element.

3. The light emitting device as in claim 1, wherein the light emerging surface having a surface profile that reduces total internal reflection at the light emerging surface.

4. The light emitting device as in claim 1, wherein the corner surface profiles comprise at least one of:
an arcuate profile,
a faceted profile, and
a beveled profile.

5. The light emitting device as in claim 1, wherein the optical enhancement structure directs diverging light from the light emitting element along a path within the optical enhancement structure in a direction towards a normal of the light emitting element.

6. The light emitting device as in claim 5, wherein the optical enhancement structure bends diverging light from the light emitting element to transmit along a path within the optical enhancement structure towards closer to the normal of the light emitting element.

7. The light emitting device as in claim 6, further comprising a passivation layer between the light emitting element and the optical enhancement structure, wherein the refractive index of the passivation layer is higher than the refractive index of the optical enhancement structure.

8. The light-emitting device as in claim 1, wherein the optical enhancement structure comprises at least two adjacent optical elements positioned along direction of the normal of the light emitting element, the adjacent optical elements having a continuous interfacing surface between the adjacent optical elements, wherein the interfacing surface includes a central surface that is orthogonal to the normal of the light emitting element, and corner surfaces contiguous to both ends of the flat central surface, wherein the corner surfaces have profiles that are not orthogonal to the normal of the light emitting element.

9. The light emitting device as in claim 8, wherein one of the two optical elements further from the light emitting element comprises a substantially flat light emerging surface.

10. The light emitting device as in claim 8, wherein one of the two optical elements closer to the light emitting element comprises a substantially flat light emerging surface.

11. The light emitting device as in claim 8, wherein the optical element closer to the light emitting element has a higher refractive index than the optical element further from the light emitting element.

12. The light emitting device as in claim 1, wherein the light emitting element is one of OLED, PLED and plasma panel display.

13. A display device, comprising:
a light emitting device as in claim 1; and
a controller operatively controlling the light emitting element of each pixel.

14. An electronic device, comprising:
the display device as in claim 13; and
a control device operatively controlling the operation of the display device to display an image in accordance with image data.

15. A light emitting device having a plurality of pixels, each pixel defined by a structure comprising:
a light emitting element, wherein some of the light from the light emitting element is emitted in a diverging manner; and
an optical enhancement structure, having an optical characteristic that directs diverging light from the light emitting element along a path within the optical enhancement structure in a direction towards a normal of the light emitting element, wherein the optical enhancement structure comprises a light emerging surface that includes a flat central surface of a defined width that is orthogonal to the normal, and corner surfaces contiguous to both ends of the flat central surface, wherein the corner surface have profiles that are not orthogonal to the normal.

16. The light emitting device as in claim 15, wherein the optical characteristic of the optical enhancement structure comprises a refractive index distribution profile that bends within the optical enhancement structure, the diverging light from the light emitting element towards closer to the normal.

17. The light emitting device as in claim 16, wherein the refractive index distribution profile comprises a gradient of refractive indices in the direction of the normal.

18. The light emitting device as in claim 17, wherein the refractive index distribution profile comprises refractive indices that decrease in the normal direction.

19. The light emitting device as claimed in claim 1, wherein the light emitting element comprises:
a first electrode;
an organic light emitting layer formed on the first electrode; and
a second electrode formed on the organic light emitting layer.

20. A method of enhancing light output from a light emitting element of a pixel in a light emitting device, comprising the steps of:
providing an optical enhancement structure that has a single convex light emerging surface, said optical enhancement structure having an optical characteristic that refracts incident light to transmit along a path within the optical enhancement structure towards a normal of the light emerging surface, wherein the optical enhancement structure comprises a light emerging surface that includes a flat central surface of a defined width that is orthogonal to the normal, and corner surfaces contiguous to both ends of the flat central surface, wherein the corner surfaces have profiles that are not orthogonal to the normal; and
optically coupling the optical enhancement structure to the light emitting element to direct diverging light from the light emitting element along a path within the optical enhancement structure towards the normal of the light emerging surface.
